(19) United States
(12) Patent Application Publication
(10) Pub. No.: US 2019/0255916 A1
(43) Pub. Date: Aug. 22, 2019

(54) HVAC CONDENSER ASSEMBLY FOR A WORK VEHICLE

(71) Applicant: CNH Industrial America LLC, New Holland, PA (US)

(72) Inventor: Mark Douglas Klassen, Lockport, IL (US)

(73) Assignee: CNH Industrial America LLC

(21) Appl. No.: 15/902,152

(22) Filed: Feb. 22, 2018

(51) Int. Cl. B60H 1/32; B60H 1/00

(52) U.S. Cl. CPC B60H 1/3227; B60H 1/00328; B60H 1/323; B60H 1/00378

(57) ABSTRACT

A heating, ventilation, and air conditioning (HVAC) condenser assembly for a work vehicle includes a first condenser configured to be positioned within a body of the work vehicle forward of cooling package relative to a direction of an airflow through the first condenser and the cooling package. The cooling package includes at least one heat exchanger. The HVAC condenser assembly also includes a second condenser configured to be positioned within the body and to receive the airflow from the cooling package. The second condenser and the first condenser are fluidly coupled to one another, the second condenser is configured to receive refrigerant from a compressor, and the first condenser is configured to receive the refrigerant from the second condenser.

### BACKGROUND

The present disclosure relates generally to an HVAC condenser assembly for a work vehicle.

Certain work vehicles (e.g., tractors, harvesters, skid steers, etc.) include a heating, ventilation, and air conditioning (HVAC) system configured to control an air temperature within an interior of a cab of the work vehicle. For example, certain HVAC systems are configured to reduce the air temperature within the interior of the cab (e.g., during warmer months). Such HVAC systems typically include a condenser, an evaporator, and a compressor. Refrigerant evaporates within the evaporator, thereby cooling an airflow through the evaporator. The airflow is directed to the interior of the cab to reduce the air temperature within the interior of the cab. Low-pressure refrigerant vapor flows from the evaporator to the compressor, which compresses the low-pressure refrigerant vapor into high-pressure refrigerant vapor. The high-pressure refrigerant vapor then flows to the condenser, where the high-pressure refrigerant vapor is condensed into liquid refrigerant, which is directed toward the evaporator (e.g., via an expansion valve).

Certain condensers receive an airflow from the environment to cool the refrigerant. The size of such condensers is based on the target cooling capacity of the HVAC system (e.g., an HVAC system with a higher target cooling capacity may have a larger condenser than an HVAC system within a lower target cooling capacity). A larger condenser may facilitate more heat transfer to the airflow (e.g., as compared to a smaller condenser). The airflow from the condenser is then utilized within a cooling package having one or more heat exchangers (e.g., an engine radiator, a charge air cooler, an oil cooler, etc.). Due to the increased heat of the airflow from the condenser, the size of the downstream heat exchanger(s) may be increased to enable the heat exchanger(s) to provide sufficient cooling. Unfortunately, increasing the size of the heat exchanger(s) may cause the body of the work vehicle (e.g., the hood of the work vehicle) to increase, thereby reducing driver visibility.

### BRIEF DESCRIPTION

In one embodiment, a heating, ventilation, and air conditioning (HVAC) condenser assembly for a work vehicle includes a first condenser configured to be positioned within a body of the work vehicle forward of a cooling package relative to a direction of an airflow through the first condenser and the cooling package. The cooling package includes at least one heat exchanger. The HVAC condenser assembly also includes a second condenser configured to be positioned within the body and to receive the airflow from the cooling package. The second condenser and the first condenser are fluidly coupled to one another, the second condenser is configured to receive refrigerant from a compressor, and the first condenser is configured to receive the refrigerant from the second condenser.

In another embodiment, a cooling system for a work vehicle includes a cooling package configured to be positioned within a body of the work vehicle. The cooling package includes at least one heat exchanger. The cooling system also includes a heating, ventilation, and air conditioning (HVAC) condenser assembly having a first condenser configured to be positioned within the body of the work vehicle. The first condenser is positioned forward of the cooling package relative to a direction of an airflow through the first condenser and the cooling package. In addition, the HVAC condenser assembly includes a second condenser configured to be positioned within the body of the work vehicle. The second condenser is configured to receive the airflow from the cooling package, and the second condenser and the first condenser are fluidly coupled to one another. Furthermore, the second condenser is configured to receive refrigerant from a compressor, and the first condenser is configured to receive the refrigerant from the second condenser.

In a further embodiment, a work vehicle includes a body and a cooling package positioned within the body. The cooling package includes at least one heat exchanger. The work vehicle also includes a heating, ventilation, and air conditioning (HVAC) condenser assembly, which includes a first condenser positioned within the body. The first condenser is positioned forward of the cooling package relative to a direction of an airflow through the first condenser and the cooling package. The HVAC condenser assembly also includes a second condenser positioned within the body. The second condenser is configured to receive the airflow from the cooling package, and the second condenser and the first condenser are fluidly coupled to one another. In addition, the second condenser is configured to receive refrigerant from a compressor, and the first condenser is configured to receive the refrigerant from the second condenser.

### DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of a work vehicle that may include a cooling system having a heating, ventilation, and air conditioning (HVAC) condenser assembly;

FIG. 2 is a block diagram of an embodiment of a cooling system that may be employed within the work vehicle of FIG. 1;

FIG. 3 is a perspective view of a portion of an embodiment of a cooling system that may be employed within the work vehicle of FIG. 1; and

FIG. 4 is a perspective view of another portion of the cooling system of FIG. 3.

### DETAILED DESCRIPTION

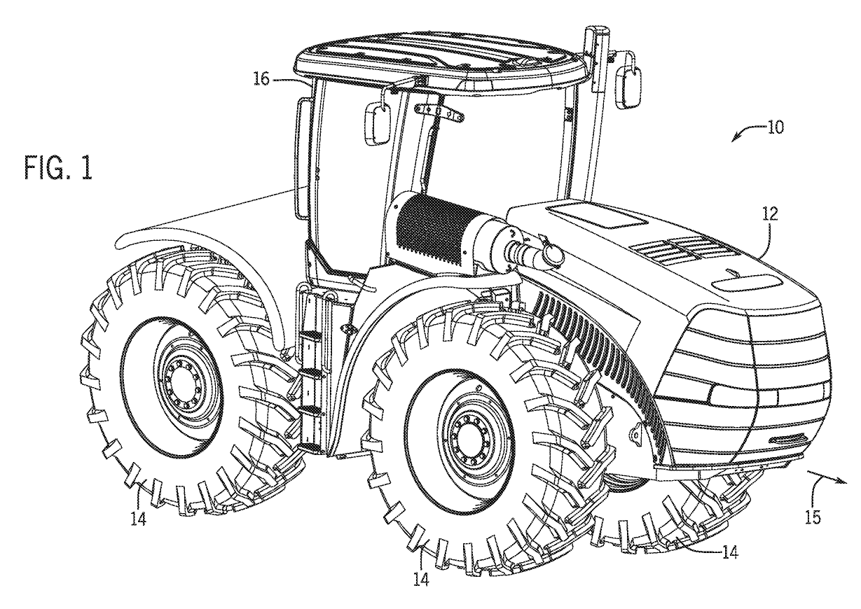

Turn now to the drawings, FIG. 1 is a perspective view of an embodiment of a work vehicle 10 that may include a cooling system having a heating, ventilation, and air conditioning (HVAC) condenser assembly. In the illustrated embodiment, the work vehicle 10 includes a body 12 configured to house an engine, a transmission, other systems of the work vehicle 10, or a combination thereof. In addition, the work vehicle 10 includes wheels 14 configured to be driven by the engine and transmission, thereby driving the work vehicle 10 along a field, a road, or any other suitable surface in a direction of travel 15. While the illustrated work vehicle 10 includes wheels 14, in alternative embodiments, the work vehicle may include tracks or a combination of wheels and tracks. In the illustrated embodiment, the work vehicle 10 includes a cab 16 configured to house an operator. As discussed in detail below, the work vehicle may include an HVAC system configured to control an air temperature within the cab. In certain embodiments, the HVAC system includes a condenser assembly having multiple condensers. The condenser assembly is fluidly coupled to a compressor of the HVAC system, and the compressor is fluidly coupled to an evaporator of the HVAC system. Liquid refrigerant evaporates within the evaporator, thereby cooling an airflow through the evaporator. The airflow is directed to the interior of the cab to reduce the air temperature within the interior of the cab. Low-pressure refrigerant vapor flows from the evaporator to the compressor, which compresses the low-pressure refrigerant vapor into high-pressure refrigerant vapor. The high-pressure refrigerant vapor then flows to the condenser assembly, where the high-pressure refrigerant vapor is condensed to liquid refrigerant, which is directed toward the evaporator (e.g., via an expansion valve).

In certain embodiments, the HVAC condenser assembly includes a first condenser positioned within the body of the work vehicle (e.g., within the hood of the work vehicle). The first condenser is positioned forward (e.g., upstream) of a cooling package relative to a direction of an airflow through the first condenser and the cooling package. The cooling package includes at least one heat exchanger, such as an engine radiator, an oil cooler, a charge air cooler, etc. In addition, the condenser assembly includes a second condenser positioned within the body. The second condenser is configured to receive the airflow from the cooling package, and the second condenser and the first condenser are fluidly coupled to one another. The second condenser is configured to receive refrigerant from a compressor, and the first condenser is configured to receive the refrigerant from the second condenser. Because the HVAC system includes a second condenser positioned to receive the airflow from the cooling package, the size of the first condenser may be reduced, as compared to an HVAC system having a single condenser positioned forward (e.g., upstream) of the cooling package relative to the direction of the airflow through the condenser and the cooling package. Reducing the size of the first condenser may enable the hood of the work vehicle to be smaller, thereby enhancing operator visibility (e.g., in a forward direction relative to the direction of travel 15). While the illustrated work vehicle 10 is a tractor, the HVAC condenser assembly described herein may be employed within any other suitable type of work vehicle, such as a harvester, a sprayer, or a skid steer, among others.

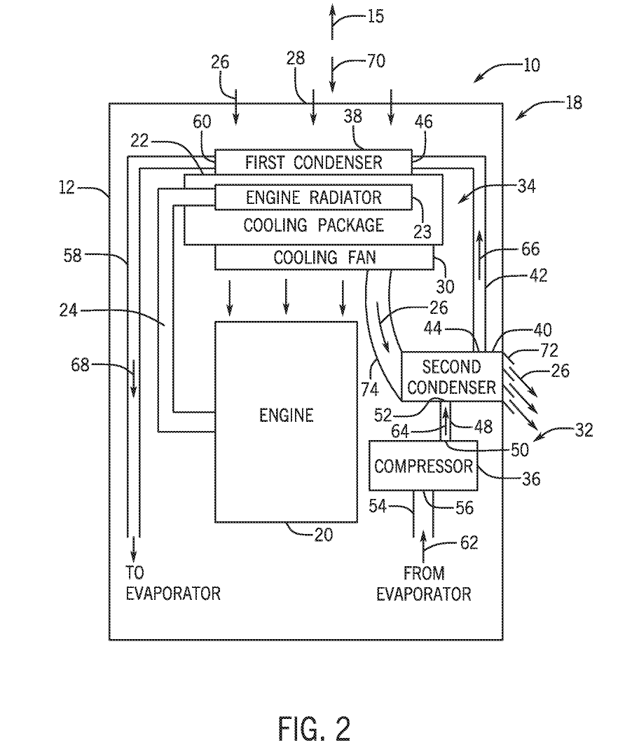

FIG. 2 is a block diagram of an embodiment of a cooling system 18 that may be employed within the work vehicle 10 of FIG. 1. In the illustrated embodiment, the work vehicle 10 includes an engine 20, and the cooling system 18 of the work vehicle 10 includes a cooling package 22 having an engine radiator 23. As illustrated, the engine 20 and the cooling package 22 are positioned within the body 12 (e.g., the hood) of the work vehicle 10. The engine 20 is configured to drive the wheels and/or tracks of the work vehicle (e.g., via a transmission, via a hydraulic system, etc.) to propel the work vehicle along a surface in the direction of travel 15. The engine radiator 23 of the cooling package 22 is fluidly coupled to the engine 20 by a conduit 24 (e.g., radiator hose). Coolant (e.g., water, anti-freeze, etc.) may circulate between the engine radiator 23 and the engine 20 (e.g., via a coolant pump) to cool the engine 20 during operation of the work vehicle 10. While the cooling package 22 includes the engine radiator 23 in the illustrated embodiment, the cooling package 22 may also include other heat exchanger(s), such as an oil cooler and/or a charger air cooler, among others. Furthermore, in certain embodiments, one or more heat exchangers of the work vehicle (e.g., the engine radiator, the charge air cooler, the oil cooler, etc.) may be located outside of the cooling package 22 (e.g., at other suitable location(s) within the body 12). For example, in certain embodiments, the cooling package may not include the engine radiator.

As illustrated, an airflow 26 enters the body 12 via a grill 28 and flows through the cooling package 22. As the airflow 26 flows through the cooling package 22, the airflow 26 flows through each heat exchanger of the cooling package 22, including the engine radiator 23 in the illustrated embodiment. As the airflow 26 flows through the engine radiator 23, heat is transferred from the coolant within the engine radiator 23 to the airflow 26, thereby cooling the coolant. In the illustrated embodiment, the cooling system 18 includes a cooling fan 30, which may be driven by an electric motor or by the engine, for example. The cooling fan 30 is configured to draw the airflow 26 through the grill 28 and the cooling package 22, as illustrated. In addition, movement of the work vehicle 10 in the direction of travel 15 may also drive the airflow 26 through the grill 28 and the cooling package 22.

In the illustrated embodiment, the cooling system 18 includes an HVAC system 32, which includes an HVAC condenser assembly 34, a compressor 36, and an evaporator. The condenser assembly 34 includes a first condenser 38, a second condenser 40, and a first conduit 42. The first conduit 42 extends between an outlet 44 of the second condenser 40 and an inlet 46 of the first condenser 38, thereby fluidly coupling the first condenser 38 and the second condenser 40. In addition, a second conduit 48 extends between an outlet 50 of the compressor 36 and an inlet 52 of the second condenser 40, thereby fluidly coupling the compressor 36 and the second condenser 40. A third conduit 54 extends between an outlet of the evaporator and an inlet 56 of the compressor 36, thereby fluidly coupling the evaporator and the compressor 36, and a fourth conduit 58 extends between an outlet 60 of the first condenser 38 and an inlet of the evaporator, thereby fluidly coupling the first compressor 38 to the evaporator.

As previously discussed, liquid refrigerant within the evaporator may evaporate, thereby cooling an airflow through the evaporator. The airflow through the evaporator may be directed to the interior of the cab to reduce the air temperature within the interior of the cab. As the liquid refrigerant evaporates within the evaporator, low-pressure refrigerant vapor 62 is generated. The low-pressure refrigerant vapor 62 flows from the outlet of the evaporator to the inlet 56 of the compressor 36 via the third conduit 54. The compressor 36 compresses the low-pressure refrigerant vapor 62 into high-pressure refrigerant vapor 64, and the high-pressure refrigerant vapor 64 flows from the outlet 50 of the compressor 36 to the inlet 52 of the second condenser 40 via the second conduit 48. The second condenser 40 cools the high-pressure refrigerant vapor, thereby generating low-temperature high-pressure refrigerant vapor 66. In certain embodiments, the low-temperature high-pressure refrigerant vapor may include liquid refrigerant (e.g., depending on the size of the second condenser). The low-temperature high-pressure refrigerant vapor 66 flows from the outlet 44 of the second condenser 40 to the inlet 46 of the first condenser 38 via the first conduit 42. The first condenser 38 further cools the low-temperature high-pressure refrigerant vapor, thereby condensing (e.g., further condensing) the refrigerant vapor into liquid refrigerant 68. The liquid refrigerant 68 flows from the outlet 60 of the first condenser 38 to the inlet of the evaporator, where the process repeats.

As previously discussed, the airflow 26 enters the body 12 of the work vehicle 10 via the grill 28 and flows through the engine radiator 23 of the cooling package 22, thereby cooling the coolant within the engine radiator 23. In addition, the airflow 26 flows through the first condenser 38 (e.g., substantially perpendicularly to the inlet face of the first condenser), thereby cooling the refrigerant within the first condenser 38. In the illustrated embodiment, the first condenser 38 is positioned within the body 12 forward (e.g., upstream) of the cooling package 22 relative to a direction 70 of the airflow 26 through the first condenser 38 and the cooling package 22. Accordingly, the airflow 26 passes through the first condenser 38 before passing through the cooling package 22 (e.g., substantially perpendicularly to the inlet face of the engine radiator). As the airflow 26 passes through the first condenser 38, heat is transferred from the refrigerant within the first condenser to the airflow 26, thereby cooling the refrigerant and heating the airflow. As a result, the temperature of the airflow through the cooling package 22 may be greater than the temperature of the airflow through the first condenser 38. Furthermore, as the airflow 26 passes through the cooling package 22, heat is transferred from the heat exchanger(s) of the cooling package 22 to the airflow 26, thereby heating the airflow. For example, as the airflow 26 passages through the engine radiator 23, heat is transferred from the coolant within the engine radiator 23 to the airflow 26, thereby cooling the coolant and heating the airflow.

Movement of the work vehicle 10 in the direction of travel 15 at least partially establishes the airflow 26 through the first condenser 38 and the cooling package 22. Furthermore, the cooling fan 30 draws the airflow 26 through the first condenser 38 and the cooling package 22. In the illustrated embodiment, the cooling fan 30 is positioned downstream from (e.g., rearward of) the cooling package 22 relative to the direction 70 of the airflow 26 through the first condenser and the cooling package. However, in alternative embodiments, the cooling fan may be positioned upstream (e.g., forward) of the first condenser or between the first condenser and the cooling package. Furthermore, in certain embodiments, the cooling fan may be omitted, and the airflow may be established by movement of the work vehicle along the direction of travel. In addition, in certain embodiments, the cooling system may include one or more flow diverters (e.g., air dam(s), conduit(s), etc.) configured to direct the airflow through the first condenser and/or the cooling package. While the direction 70 of the airflow 26 at the first condenser 38 and the cooling package 22 is substantially opposite the direction of travel 15 in the illustrated embodiment, in other embodiments, the direction of the airflow at the first condenser/cooling package may be oriented at any suitable angle relative to the direction of travel (e.g., substantially perpendicular to the direction of travel, etc.). In such embodiments, the first condenser and/or the cooling package (e.g., at least one heat exchanger of the cooling package) may be angled such that the airflow flows through the first condenser and the cooling package (e.g., such that the direction of the airflow is substantially perpendicular to the inlet face of the first condenser and the inlet face of at least one cooling package heat exchanger, such as the engine radiator), and/or the cooling system may include one or more flow diverters configured to direct the airflow through the first condenser and the cooling package.

In the illustrated embodiment, the second condenser 40 is positioned within the body 12 and configured to receive the airflow 26 from the engine radiator 23 of the cooling package 22. For example, the airflow from the engine radiator may be about 80° C., and the refrigerant within the second condenser may be about 110° C. The second condenser 40 is configured to cool the refrigerant by facilitating the transfer of heat from the warmer refrigerant to the cooler airflow. In the illustrated embodiment, the second condenser 40 is positioned downstream from (e.g., rearward of) the cooling fan 30 relative to the direction 70 of the airflow 26. However, in embodiments that do not include a cooling fan, the second condenser may be positioned directly downstream from (e.g., rearward of) the cooling package (e.g., the engine radiator of the cooling package) relative to the direction of the airflow.

In the illustrated embodiment, the second condenser 40 is positioned directly upstream (e.g., forward) of an airflow exhaust vent 72 within the body 12 (e.g., hood) relative to the direction 70 of the airflow 26. The airflow exhaust vent 72 is configured to direct the airflow 26 from the second condenser 40 to the external environment (e.g., the environment external to the body 12). In certain embodiments, the airflow exhaust vent may also be configured to direct air from an interior of the body to the external environment (e.g., in embodiments in which the airflow exhaust vent is sized larger than the outlet face of the second condenser, and/or in embodiments in which the outlet face of the second condenser is angled relative to the inlet face of the airflow exhaust vent). In the illustrated embodiment, the second condenser 40 is substantially aligned (e.g., linearly and/or angularly) with the airflow exhaust vent 72 (e.g., the outlet face of the second condenser is substantially parallel to the inlet face of the airflow exhaust vent). However, in alternative embodiments, the second condenser may be offset (e.g., linearly and/or angularly) from the airflow exhaust vent (e.g., the outlet face of the second condenser may be angled relative to the inlet face of the airflow exhaust vent, and/or a portion of the outlet face of the second condenser may overlap a portion of the body surrounding the airflow exhaust vent). While the second condenser 40 is positioned directly upstream (e.g., forward) of the airflow exhaust vent 72 relative to the direction 70 of the airflow 26 in the illustrated embodiment, in other embodiments, the second condenser may be positioned such that the airflow from the second condenser flows through another heat exchanger before flowing through the airflow exhaust vent.

As used herein, “directly” (e.g., directly upstream, directly forward, etc.) refers to an arrangement in which no heat exchanger is positioned between the referenced elements. For example, as discussed above, the second condenser is positioned directly upstream (e.g., forward) of the airflow exhaust vent. Accordingly, no heat exchanger is positioned between the second condenser and the airflow exhaust vent. Furthermore, as used herein, “heat exchanger” refers to a device having one or more tubes and a heat transfer enhancement element coupled to the tube(s). The tube(s) are configured to flow a working fluid (e.g., coolant, refrigerant, etc.) from an inlet to an outlet of the respective heat exchanger, and the heat transfer enhancement element is configured to facilitate heat transfer from the working fluid to an airflow. Within the illustrated HVAC condenser assembly, the first condenser and the second condenser are heat exchangers. In addition, within the cooling package, the engine radiator is a heat exchanger. Accordingly, the first condenser, the second condenser, and the engine radiator each include one or more tubes and a heat transfer enhancement element coupled to the tube(s). In certain embodiments, the heat transfer enhancement element includes multiple cooling fins coupled to the tube(s). However, the heat transfer enhancement element may include any suitable structure(s) coupled to the tube(s) and configured to increase the surface area in contact with the airflow, as compared to the surface area of the tube(s) alone. While conduits of the cooling system (e.g., the first conduit, the second conduit, the third conduit, the fourth conduit, etc.) may enable heat to flow from the working fluid to the surrounding air, such conduits are not heat exchangers at least because the conduits do not include respective heat transfer enhancement elements.

In the illustrated embodiment, the cooling system 18 includes a flow diverter 74 configured to direct the airflow 26 from the cooling package 22 toward the second condenser 40. In certain embodiments, the flow diverter may include an air dam, a conduit, one or more fins, or a combination thereof, among other suitable elements configured to direct the airflow from the cooling package toward the second condenser. The flow diverter may substantially increase the airflow through the second condenser, as compared to a configuration in which air flows from the cooling package to the second condenser without the assistance of a flow diverter. In the illustrated embodiment, the flow diverter 74 extends from the cooling fan 30 to the inlet face of the second condenser 40. However, in other embodiments, the flow diverter may extend from the cooling package to the second condenser. Furthermore, in certain embodiments, the flow diverter may be omitted.

Because the HVAC system includes a second condenser positioned to receive the airflow from the cooling package (e.g., from at least one heat exchanger of the cooling package, such as the engine radiator), the size of the first condenser may be reduced, as compared to an HVAC system having a single condenser positioned forward (e.g., upstream) of the cooling package relative to the direction of the airflow through the condenser and the cooling package. Reducing the size of the first condenser may enable the hood of the work vehicle to be smaller, thereby enhancing operator visibility (e.g., in a forward direction relative to the direction of travel). In addition, because the second condenser facilitates the transfer of heat from the refrigerant to the external environment, the first condenser may facilitate less heat transfer to the airflow through the cooling package. For example, in certain configurations, a condenser assembly may facilitate the transfer of about 11 kW of power from the refrigerant to the airflow to facilitate effective operation of the HVAC system (e.g., while operating the HVAC system at a maximum capacity). If the condenser assembly includes a single condenser positioned forward (e.g., upstream) of the cooling package, the single condenser may facilitate the transfer of about 11 kW of power to the airflow, which flows through the cooling package. However, if the condenser assembly includes a second condenser positioned to receive the airflow from the cooling package, the second condenser and, in certain embodiments, the conduit extending between the condensers (e.g., the first conduit) may facilitate the transfer of about 2 kW of power to the external environment via the airflow from the cooling package. Accordingly, the first condenser may facilitate the transfer of about 9 kW of power to the airflow, which flows through the cooling package. As a result, the temperature of the airflow through the cooling package may be reduced. Accordingly, the size of the cooling package (e.g., the heat exchanger(s) of the cooling package, such as the engine radiator) may be reduced, thereby lowering the cost of the work vehicle. In addition, the cooling fan may operate at a lower speed, thereby reducing power consumption and increasing fuel efficiency.

While the illustrated HVAC condenser assembly includes two condensers, in other embodiments, the HVAC condenser assembly may include more condensers (e.g., 2, 3, 4, 5, 6, 7, 8, or more). Furthermore, in the illustrated embodiment, the cooling package includes the engine radiator. Accordingly, in certain embodiments, the airflow from the engine radiator flows through the cooling fan to the second condenser 40. In addition, in certain embodiments, the cooling package includes another heat exchanger (e.g., positioned between the engine radiator and the second condenser). In such embodiments, the airflow from the engine radiator may flow through the other heat exchanger to the second condenser. For example, the cooling package may include an oil cooler, a charge air cooler, a fuel cooler, a hydraulic fluid cooler, a heater core, or a combination thereof, among other heat exchangers. In such embodiments, at least one heat exchanger may receive the airflow from the engine radiator, and the second condenser may receive the airflow from the at least one heat exchanger (e.g., the second condenser may receive the airflow from the engine radiator via the at least one heat exchanger). In further embodiments (e.g., embodiments in which the cooling package does not include the engine radiator, embodiments in which the engine radiator and the at least one heat exchanger are not aligned with one another along the direction of the airflow, etc.), the at least one heat exchanger may receive an airflow directly from the external environment, and the second condenser may receive the airflow from the at least one heat exchanger (e.g., such that the airflow received by the second condenser does not flow through the engine radiator).

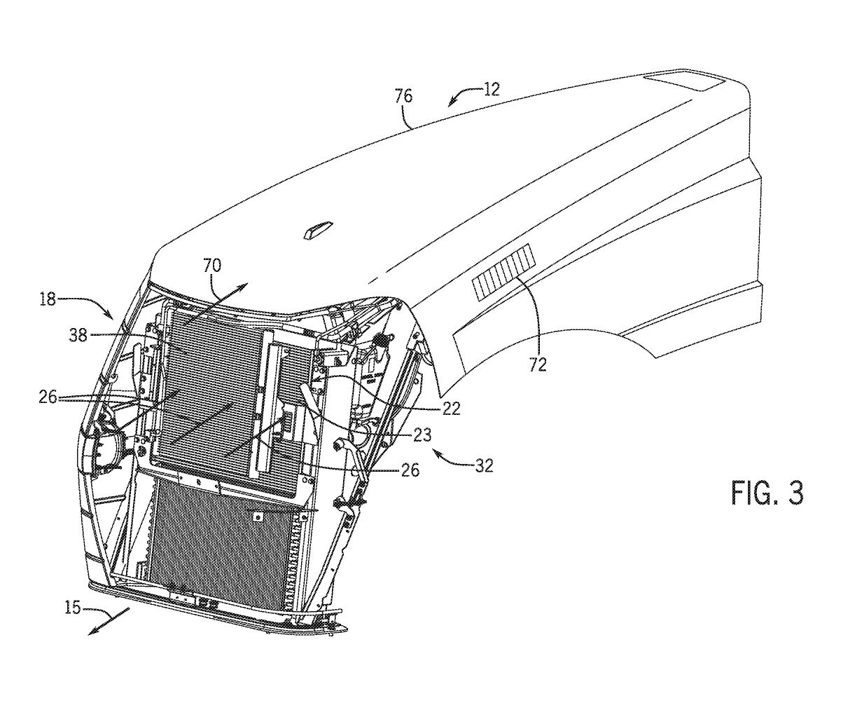

FIG. 3 is a perspective view of a portion of an embodiment of a cooling system 18 that may be employed within the work vehicle of FIG. 1. In the illustrated embodiment, a hood 76 forms a portion of the body 12 of the work vehicle. As illustrated, a portion of the hood and a grill have been removed to show the portion of the cooling system. In the illustrated embodiment, the engine radiator 23 of the cooling package 22 and the first condenser 38 are positioned within an interior of the hood 76. In addition, the first condenser 38 is positioned forward (e.g., upstream) of the cooling package 22 relative to the direction 70 of the airflow 26 through the first condenser 38 and the cooling package 22. While the first condenser 38 is positioned directly forward (e.g., upstream) of the engine radiator 23 in the illustrated embodiment, in other embodiments, the first condenser 38 may be positioned directly forward (e.g., upstream) of another heat exchanger of the cooling package 22. Furthermore, in the illustrated embodiment, the first condenser 38 covers a portion of the inlet face of the engine radiator 23. However, in other embodiments, the first condenser may cover the entire inlet face of the engine radiator (e.g., in embodiments in which the area of the first condenser outlet face is greater than the area of the engine radiator inlet face). In addition, while the inlet and outlet faces of the first condenser 38 and the engine radiator 23 are substantially parallel to one another in the illustrated embodiment, in other embodiments, the first condenser may be angled relative to the engine radiator.

In the illustrated embodiment, the hood 76 includes the airflow exhaust vent 72, which is configured to direct the airflow 26 from the second condenser to the external environment (e.g., the environment external to the hood 76). As previously discussed, the second condenser is configured to receive the airflow 26 from the cooling package 22 and to facilitate heat transfer from the refrigerant within the second condenser to the airflow, thereby cooling the refrigerant. The refrigerant flows from the second condenser to the first condenser 38 via a conduit. The first condenser 38 is configured to facilitate heat transfer from the refrigerant within the first condenser 38 to the airflow 26, thereby condensing the refrigerant. Because the HVAC system 32 includes a second condenser positioned to receive the airflow from the cooling package, the size of the first condenser 38 may be reduced, as compared to an HVAC system having a single condenser positioned forward (e.g., upstream) of the cooling package relative to the direction of the airflow through the condenser and the cooling package. Reducing the size of the first condenser may enable the hood 76 of the work vehicle to be smaller, thereby enhancing operator visibility (e.g., in a forward direction relative to the direction of travel 15). While the illustrated airflow exhaust vent 72 is positioned of a left side of the hood 76 in the illustrated embodiment, in other embodiments, the airflow exhaust vent may be positioned at any other suitable location on the hood. In further embodiments, the vent may be omitted, and the airflow from the second condenser may flow around the hood (e.g., under the hood) to the external environment.

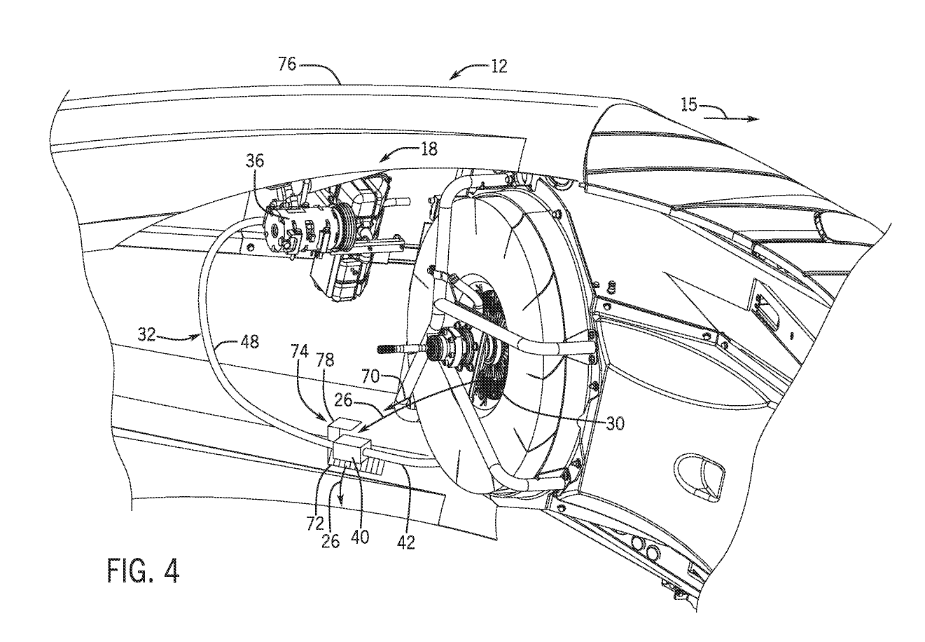

FIG. 4 is a perspective view of another portion of the cooling system 18 of FIG. 3. As previously discussed, the second condenser 40 is positioned within the hood 76 and configured to receive the airflow 26 from the cooling package. In the illustrated embodiment, the second condenser 40 is positioned downstream from (e.g., rearward of) the cooling fan 30 relative to the direction 70 of the airflow 26. Accordingly, the airflow 26 from the cooling fan 30 flows through the second condenser 40 and exits the hood 76 via the airflow exhaust vent 72, as illustrated. As previously discussed, high-pressure refrigerant vapor flows from the compressor 36 to the second condenser 40 via the second conduit 48. The second condenser 40 facilitates heat transfer from the high-pressure refrigerant vapor to the airflow 26, thereby cooling the high-pressure refrigerant vapor and generating low-temperature high-pressure refrigerant vapor (e.g., which may include liquid refrigerant in certain embodiments). The low-temperature high-pressure refrigerant vapor then flows from the second condenser 40 to the first condenser via the first conduit 42.

In the illustrated embodiment, the second condenser 40 is positioned directly upstream (e.g., forward) of the airflow exhaust vent 72 relative to the direction 70 of the airflow 26. The exhaust vent 72 is configured to direct/facilitate the airflow 26 from the second condenser 40 to the external environment (e.g., the environment external to the hood 76). In the illustrated embodiment, the airflow exhaust vent 72 is larger than the outlet face of the second condenser 40. Accordingly, the airflow exhaust vent 72 may enable air within the interior of the hood 76 to flow to the external environment (e.g., around the second condenser). However, in alternative embodiments, the outlet face of the second condenser may be larger than the airflow exhaust vent (e.g., such that the second condenser covers the entire airflow exhaust vent). In the illustrated embodiment, the second condenser 40 is substantially aligned (e.g., linearly and/or angularly) with the airflow exhaust vent 72 (e.g., the outlet face of the second condenser is substantially parallel to the inlet face of the airflow exhaust vent). However, in alternative embodiments, the second condenser may be offset (e.g., linearly and/or angularly) from the airflow exhaust vent (e.g., the outlet face of the second condenser may be angled relative to the inlet face of the airflow exhaust vent, and/or a portion of the outlet face of the second condenser may overlap a portion of the hood surrounding the airflow exhaust vent). While the second condenser 40 is positioned directly upstream (e.g., forward) of the airflow exhaust vent 72 relative to the direction 70 of the airflow 26 in the illustrated embodiment, in other embodiments, the second condenser may be positioned such that the airflow from the second condenser flows through another heat exchanger before flowing through the airflow exhaust vent. For example, the second condenser may be positioned in another suitable location within the interior of the hood.

As previously discussed, the flow diverter 74 is configured to direct the airflow 26 from the cooling fan 30 toward the second condenser 40. In the illustrated embodiment, the flow diverter 74 includes an air dam 78 positioned behind the airflow exhaust vent 72 relative to the direction of travel 15. The air dam 78 is configured to block the airflow 26 from the cooling fan 30 in a direction opposite the direction of travel 15, and to direct the airflow 26 through the second condenser 40. The air dam 78 may substantially increase the airflow through the second condenser 40, as compared to a configuration in which air flows from the cooling fan to the second condenser without the assistance of a flow diverter. The air dam 78 may have any suitable shape that facilitates directing the airflow from the cooling fan 30 to the second condenser 40. Furthermore, while the air dam 78 is positioned behind the airflow exhaust vent 72 relative to the direction of travel 15 in the illustrated embodiment, in other embodiments, the air dam may extend along any suitable side of the airflow exhaust vent to facilitate directing the airflow from the cooling fan to the second condenser. While the illustrated flow diverter includes an air dam, in other embodiments, the flow diverter may include a conduit and/or fins (e.g., in addition to the air dam or instead of the air dam). Furthermore, in certain embodiments, the flow diverter may be omitted.

While only certain features have been illustrated and described herein, many modifications and changes will occur to those skilled in the art. It is, therefore, to be understood that the appended claims are intended to cover all such modifications and changes as fall within the true spirit of the disclosure.

1. A heating, ventilation, and air conditioning (HVAC) condenser assembly for a work vehicle, comprising:
a first condenser configured to be positioned within a body of the work vehicle forward of a cooling package relative to a direction of an airflow through the first condenser and the cooling package, wherein the cooling package comprises at least one heat exchanger; and
a second condenser configured to be positioned within the body and to receive the airflow from the cooling package, wherein the second condenser and the first condenser are fluidly coupled to one another;
wherein the second condenser is configured to receive refrigerant from a compressor, and the first condenser is configured to receive the refrigerant from the second condenser.

2. The HVAC condenser assembly of claim 1, wherein the second condenser is configured to be positioned downstream from a cooling fan relative to the direction of the airflow.

3. The HVAC condenser assembly of claim 1, wherein the second condenser is configured to be positioned directly upstream of an airflow exhaust vent within the body relative to the direction of the airflow.

4. The HVAC condenser assembly of claim 1, wherein the at least one heat exchanger comprises an engine radiator.

5. The HVAC condenser assembly of claim 1, comprising a conduit extending between an outlet of the second condenser and an inlet of the first condenser, wherein the conduit is configured to fluidly couple the second condenser to the first condenser.

6. A cooling system for a work vehicle, comprising:
a cooling package configured to be positioned within a body of the work vehicle, wherein the cooling package comprises at least one heat exchanger; and
a heating, ventilation, and air conditioning (HVAC) condenser assembly, comprising:
a first condenser configured to be positioned within the body of the work vehicle, wherein the first condenser is positioned forward of the cooling package relative to a direction of an airflow through the first condenser and the cooling package; and
a second condenser configured to be positioned within the body of the work vehicle, wherein the second condenser is configured to receive the airflow from the cooling package, and wherein the second condenser and the first condenser are fluidly coupled to one another;
wherein the second condenser is configured to receive refrigerant from a compressor, and the first condenser is configured to receive the refrigerant from the second condenser.

7. The cooling system of claim 6, comprising a cooling fan positioned downstream from the cooling package relative to the direction of the airflow, wherein the cooling fan is configured to drive the airflow through the cooling package, the first condenser, and the second condenser.

8. The cooling system of claim 7, wherein the second condenser is positioned downstream from the cooling fan relative to the direction of the airflow.

9. The cooling system of claim 6, comprising a flow diverter configured to direct the airflow from the cooling package toward the second condenser.

10. The cooling system of claim 6, wherein the at least one heat exchanger comprises an engine radiator, and the engine radiator is configured to receive coolant from an engine and to provide the coolant to the engine.

11. The cooling system of claim 6, wherein the second condenser is configured to be positioned directly upstream of an airflow exhaust vent within the body relative to the direction of the airflow.

12. The cooling system of claim 6, wherein the second condenser is configured to be substantially aligned with an airflow exhaust vent within the body.

13. A work vehicle, comprising:
a body;
a cooling package positioned within the body, wherein the cooling package comprises at least one heat exchanger; and
a heating, ventilation, and air conditioning (HVAC) condenser assembly, comprising:
a first condenser positioned within the body, wherein the first condenser is positioned forward of the cooling package relative to a direction of an airflow through the first condenser and the cooling package; and
a second condenser positioned within the body, wherein the second condenser is configured to receive the airflow from the cooling package, and wherein the second condenser and the first condenser are fluidly coupled to one another;
wherein the second condenser is configured to receive refrigerant from a compressor, and the first condenser is configured to receive the refrigerant from the second condenser.

14. The work vehicle of claim 13, wherein the at least one heat exchanger comprises an engine radiator, and the engine radiator is configured to receive coolant from an engine and to provide the coolant to the engine.

15. The work vehicle of claim 13, wherein the body has an airflow exhaust vent configured to enable the airflow to discharge to an external environment, and the second condenser is positioned directly upstream of the airflow exhaust vent relative to the direction of the airflow.

16. The work vehicle of claim 13, wherein the body has an airflow exhaust vent configured to enable the airflow to discharge to an external environment, and the second condenser is substantially aligned with the airflow exhaust vent.

17. The work vehicle of claim 13, comprising a cooling fan positioned downstream from the cooling package relative to the direction of the airflow, wherein the cooling fan is configured to drive the airflow through the cooling package, the first condenser, and the second condenser.

18. The work vehicle of claim 17, wherein the second condenser is positioned downstream from the cooling fan relative to the direction of the airflow.

19. The work vehicle of claim 13, comprising a flow diverter configured to direct the airflow from the cooling package toward the second condenser.

20. The work vehicle of claim 19, wherein the flow diverter comprises an air dam.
